(19) United States
(12) Patent Application Publication
(10) Pub. No.: US 2013/0050532 A1
(43) Pub. Date: Feb. 28, 2013

(54) COMPOUND-EYE IMAGING DEVICE

(71) Applicants: Yuki UEDA, Osaka (JP); Taizo AOKI, Hyogo (JP)

(72) Inventors: Yuki UEDA, Osaka (JP); Taizo AOKI, Hyogo (JP)

(73) Assignee: Panasonic Corporation, Osaka (JP)

(21) Appl. No.: 13/593,511

(22) Filed: Aug. 24, 2012

(30) Foreign Application Priority Data
Aug. 25, 2011 (JP) 2011-183830

(51) Int. Cl. H04N 5/225; H04N 5/262

(52) U.S. Cl. 348/239; 348/222.1; 348/E05.024; 348/E05.056

(57) ABSTRACT

The multi-eye imaging device includes a first imaging element, a second imaging element, a moving pictures release button, a still picture release button, an image processor, a monitor and an image display component. The first imaging element outputs first image data. The second imaging element outputs second image data. The moving pictures release button receives a capturing instruction of moving pictures. The still picture release button receives a capturing instruction of a still picture and an AF controlling instruction on the second imaging element. The image processor captures moving pictures based on the first image data. The image display component displays a still picture mark with the first through image and the second through image on the monitor when the still picture release button has received the AF controlling instruction while the image processor is capturing the moving pictures.

### PRIORITY

This application claims priority under 35 U.S.C. §119 to Japanese Patent Application No. 2011-183830, filed on Aug. 25, 2011. The entire disclosure of Japanese Patent Application No. 2011-183830 is hereby incorporated herein by reference.

### BACKGROUND

1. Technical Field

The present invention relates to a multi-eye imaging device equipped with two or more optical systems.

2. Background Information

Japanese Laid-Open Patent Application 2011-45039 discloses a method in which, in a digital camera comprising a first imaging element and a second imaging element with mutually different sizes, a first through image captured by the first imaging element and a second through image captured by the second imaging element are displayed side by side on a monitor.

### SUMMARY

We can imagine a scenario in which a moving pictures corresponding to a first through image is captured while a still picture corresponding to a second through image is captured.

In this case, however, since the first through image and the second through image are displayed side by side, it is difficult for the user to know which of the through images corresponds to the moving pictures capture and which to still picture capture.

The present invention was conceived in light of the above problem, and it is an object thereof to provide a multi-eye imaging device with which it is easy to determine which of a first through image and a second through image corresponds to moving picture capture, and which to still picture capture.

The multi-eye imaging device includes a first imaging element, a second imaging element, a moving pictures release button, a still picture release button, an image processor, a monitor, and an image display component. The first imaging element is configured to capture a subject image and output first image data. The second imaging element is configured to capture a subject image and output second image data. The moving pictures release button is configured to receive a capturing instruction of moving pictures corresponding to the first image data. The still picture release button is configured to receive a capturing instruction of a still picture corresponding to the second image data and an AF controlling instruction of a subject on the second imaging element. The image processor is configured to begin to capture moving pictures based on the first image data when the moving pictures release button has received the capturing instruction of the moving pictures. The monitor is configured to display a first through image corresponding to the first image data and a second through image corresponding to the second image data. The first through image is displayed side by side with the second through image. The image display component is configured to display a still picture mark with the first through image and the second through image on the monitor when the still picture release button has received the AF controlling instruction while the image processor is capturing the moving pictures. The still picture mark shows that a still picture corresponding to the second through image is to be captured.

The present invention provides a multi-eye imaging device with which it is easy to determine which of a first through image and a second through image corresponds to moving pictures capture and which to still picture capture.

### BRIEF DESCRIPTION OF DRAWINGS

FIG. 1 is a block diagram of a configuration of a digital camera;

FIG. 2 is a block diagram of a configuration of a controller;

FIG. 3 is a flowchart illustrating a simplified imaging operation of a digital camera;

FIG. 4 is a flowchart illustrating a moving pictures capture operation of a digital camera;

FIG. 5 is a flowchart illustrating a still picture capture operation of a digital camera;

FIG. 6 is a simplified diagram of an example of display on a liquid crystal monitor;

FIG. 7 is a simplified diagram of an example of display on a liquid crystal monitor;

FIG. 8 is a simplified diagram of an example of display on a liquid crystal monitor; and

FIG. 9 is a simplified diagram of an example of display on a liquid crystal monitor.

### DETAILED DESCRIPTION

An application of the present invention to a digital camera will now be described with references to the drawings. It will be apparent to those skilled in the art from this disclosure that the following descriptions of the embodiments are provided for illustration only and not for the purpose of limiting the invention as defined by the appended claims and their equivalents.

### 1-1. Digital Camera

First, a configuration of a digital camera will be described.

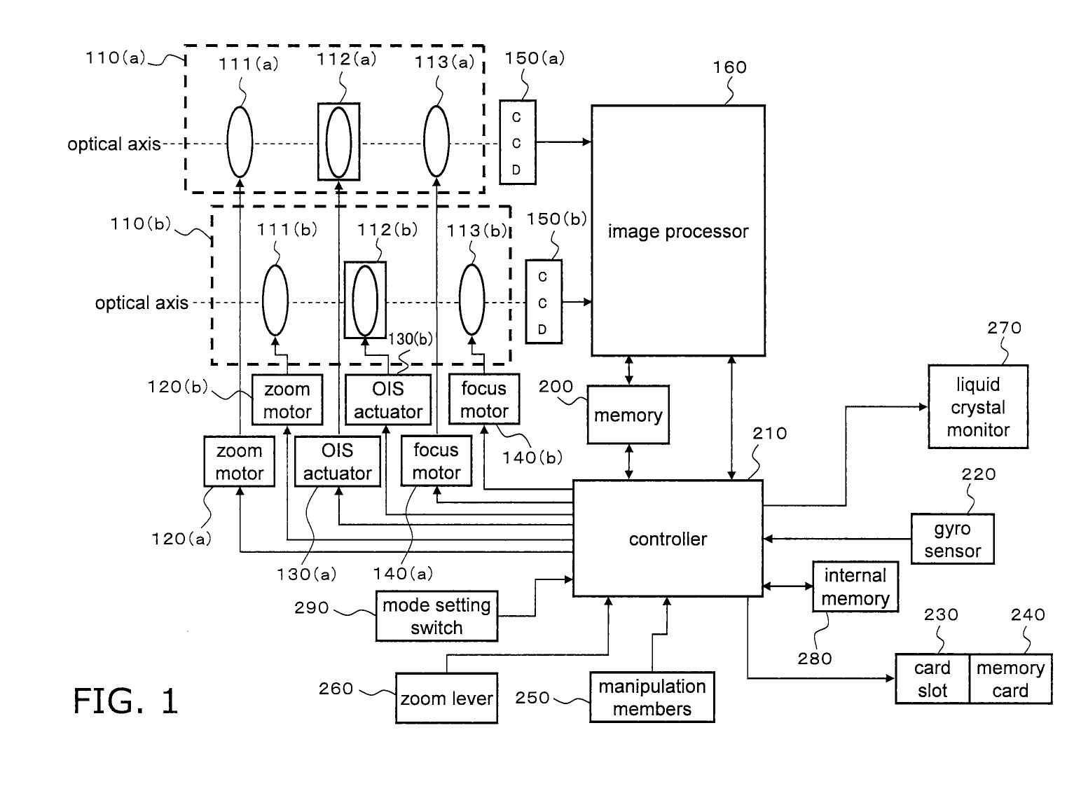

FIG. 1 is a block diagram of the electrical configuration of a digital camera 1 in an exemplary embodiment.

The electrical configuration of the digital camera 1 pertaining to this embodiment will be described through reference to FIG. 1. The digital camera 1 comprises optical systems 110(a) and 110(b), zoom motors 120(a) and 120(b), OIS actuators 130(a) and 130(b), focus motors 140(a) and 140(b), CCD image sensors 150(a) and 150(b), an image processor 160, a memory 200, a controller 210, a gyro sensor 220, a card slot 230, a memory card 240, manipulation members 250, a zoom lever 260, a liquid crystal monitor 270 (an example of a “monitor”), an internal memory 280, and a mode setting switch 290.

The optical system 110(a) includes a zoom lens 111(a), an OIS 112(a), and a focus lens 113(a). The optical system 110(b) includes a zoom lens 111(b), an OIS 112(b), and a focus lens 113(b). The optical system 110(a) forms a subject image at a first viewpoint. The optical system 110(b) forms a subject image at a second viewpoint that is different from the first viewpoint. In this embodiment, the first viewpoint corresponds to the left eye of the user, and the second viewpoint corresponds to the right eye of the user.

The zoom lenses 111(a) and 111(b) move along the optical axes of the optical systems 110(a) and 110(b), respectively, and are thereby able to enlarge or reduce the subject images formed by the CCD image sensors 150(a) and 150(b). The drive of the zoom lenses 111(a) and 111(b) is controlled by the zoom motors 120(a) and 120(b), respectively.

The OIS's 112(a) and 112(b) each have an internal correcting lens that can move in a plane that is perpendicular to the optical axis. The OIS's 112(a) and 112(b) reduce blurring of the subject image by driving the correcting lenses in directions that cancel out shaking of the digital camera 1. The drive of the OIS's 112(a) and 112(b) is controlled by the OIS actuators 130(a) and 130(b), respectively.

The focus lenses 113(a) and 113(b) move along the optical axes of the optical systems 110(a) and 110(b), respectively, and are thereby able to adjust the focus of the subject images formed by the CCD image sensors 150(a) and 150(b). The focus lenses 113(a) and 113(b) are controlled by the focus motors 140(a) and 140(b), respectively.

In the following description, the optical systems 110(a) and 110(b) will sometimes be collectively referred to simply as the optical systems 110. The same applies to the zoom lenses 111, the OIS's 112, the focus lenses 113, the zoom motors 120, the OIS actuators 130, the focus motors 140, and the CCD image sensors 150.

The zoom motors 120(a) and 120(b) control the drive of the zoom lenses 111(a) and 111(b), respectively. The zoom motors 120(a) and 120(b) may be pulse motors, DC motors, linear motors, servo motors, or the like. The zoom motors 120(a) and 120(b) may also drive the zoom lenses 111(a) and 111(b) via a cam mechanism, a ball screw, or another such mechanism. They may also be configured to control the zoom lenses 111(a) and 111(b) with the same operation.

The OIS actuators 130(a) and 130(b) control the drive of the correcting lenses in the OIS's 112(a) and 112(b) within a plane that is perpendicular to the optical axis. The OIS actuators 130(a) and 130(b) can be a planar coil, an ultrasonic motor, or the like.

The focus motors 140(a) and 140(b) control the drive of the focus lenses 113(a) and 113(b). The focus motors 140(a) and 140(b) may be pulse motors, DC motors, linear motors, servo motors, or the like. The focus motors 140(a) and 140(b) may also drive the focus lenses 113(a) and 113(b) via a cam mechanism, a ball screw, or another such mechanism.

The CCD image sensors 150(a) and 150(b) capture subject images formed by the optical systems 110(a) and 110(b) and produce first image data and second image data. The CCD image sensors 150(a) and 150(b) are spaced apart by a specific gap (such as about 3 cm) in the left and right direction. In this embodiment, the first image data is a signal indicating a left-eye image, and the second image data is a signal indicating a right-eye image.

The CCD image sensors 150(a) and 150(b) perform various operations, such as exposure, transfer, and electronic shuttering. The CCD image sensor 150(a) is an example of a “first imaging element,” and the CCD image sensor 150(b) is an example of a “second imaging element.”

The image processor 160 subjects the first image data and second image data produced by the CCD image sensors 150(a) and 150(b) to various kinds of processing (such as gamma correction, white balance correction, and scratch correction). Consequently, the image processor 160 produces image data for display on the liquid crystal monitor 270, or produces image data to be stored on the memory card 240. For example, the image processor 160 starts the production of moving pictures image data on the basis of first image data when the moving pictures release button (discussed below) has been receive a capturing instruction of moving pictures, and ends the production of moving pictures image data when the moving pictures release button is pressed again. In this embodiment, “during moving pictures capture” means from the start to the end of the production of moving pictures image data by the image processor 160. Also, the image processor 160 starts the production of still picture image data from the first and second image data when the still picture release button (discussed below) has been pressed to capture a still picture.

Also, the image processor 160 subjects the first image data and second image data to edge enhancement processing or other such enhancement processing on the basis of a control signal from the controller 210.

The image processor 160 also subjects the first image data and second image data to cropping in the processing of 3D images. More specifically, the image processor 160 corrects the cropping position in the vertical direction of the first image data and second image data so that there will be an offset in the vertical direction between the first image data and the second image data constituting the 3D image, and no discomfort will be caused to an observer. Also, to control the three-dimensional sensation when a 3D image is reproduced, the image processor 160 can adjust the parallax between the two viewpoints by changing the cropping positions in the horizontal direction of the first image data and second image data. The “three-dimensional sensation” here refers to the extent of pop-up parallax and depth parallax when the 3D image is viewed. The image data cropped by the image processor 160 is called cropped image data, in contrast to the pre-cropping signal.

The image processor 160 subjects the first image data and second image data that have undergone the above processing to compression processing in a compression format that conforms to the JPEG standard, for example. The two sets of compressed image data obtained by compressing the first image data and second image data are associated with each other and recorded to the memory card 240. In the recording of the two sets of compressed image data, the recording is preferably performed using an MPO file format. When the image data being compressed is a moving picture, an H.264/MPEG-4 AVC or other such moving pictures compression standard will be applied. The configuration may also be such that an MPO file format and a JPEG image or MPEG moving pictures are recorded simultaneously.

The image processor 160 can be a DSP, a microprocessor, or the like. The resolution (pixel count) of the through image made be set to the screen resolution of the liquid crystal monitor 270, or may be set to the resolution of the image data compressed and formed by a compression format that conforms to the JPEG standard.

The memory 200 functions as a working memory for the image processor 160 and the controller 210. For example, the memory 200 temporarily stores image data processed by the image processor 160, or image data inputted from the CCD image sensors 150 prior to being processed by the image processor 160. The memory 200 also temporarily stores imaging conditions for the optical systems 110(a) and 110(b) and the CCD image sensors 150(a) and 150(b) during imaging. “Imaging conditions” here refers to the subject distance, field angle information, ISO sensitivity, the shutter speed, the EV value, the F value, the distance between lenses, the imaging date and time, the OIS shift amount, and so forth. The memory 200 can be a DRAM, a ferroelectric memory, or the like.

The internal memory 280 is constituted by a flash memory, a ferroelectric memory, or the like. The internal memory 280 stores control programs for controlling the entire digital camera 1, and so forth.

The controller 210 is a control means for controlling everything. The controller 210 may be constituted by hardware alone, or a combination of hardware and software. The controller 210 can be a microprocessor or the like. The configuration and function of the controller 210 will be discussed below.

The gyro sensor 220 is constituted by a piezoelectric element or another such vibrating member. The gyro sensor 220 obtains angular velocity information by vibrating the piezoelectric element or other such vibrating member at a specific frequency, and converting the resulting Coriolis force into voltage. Any hand shake imparted to the digital camera 1 by the user is corrected by driving the correcting lenses inside the OIS's 112 in the direction of canceling out the shake indicated by the angular velocity information obtained from the gyro sensor 220. The gyro sensor 220 may be any device that is capable of at least measuring angular velocity information for a pitch angle. If the gyro sensor 220 is also capable of measuring angular velocity information for a yaw angle, then rotation when the digital camera 1 is moved substantially in the horizontal direction can be taken into account.

The card slot 230 allows the memory card 240 to be inserted. The card slot 230 can be mechanically and electrically connected to the memory card 240.

The memory card 240 includes an internal flash memory, ferroelectric memory, etc., and is able to store data.

“Manipulation members 250” is the collective name of a user interface that receives commands from the user. For example, it may comprise a cross key, an enter button, moving pictures release button, and a still picture release button that receives a capturing instruction of a still picture from the user. The moving pictures release button is pressed to capture moving pictures corresponding to the first image data. The still picture release button is pressed to capture a still picture corresponding to the second image data and to perform AF control of a subject on the CCD image sensor 150(b) (hereinafter referred to as AF control). More specifically, when the still picture release button is pressed half-way down, AF control and AE control are executed via the controller 210. When the release button is pressed all the way down, an image of the subject is captured.

The zoom lever 260 is a member that receives zoom ratio change commands from the user.

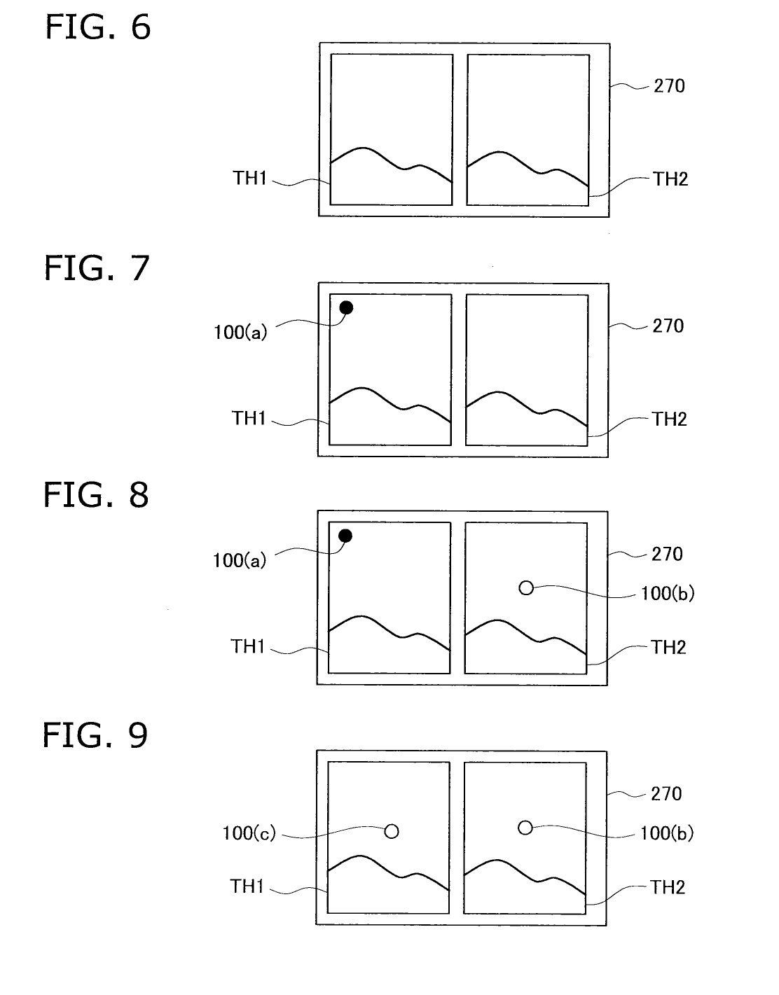

The liquid crystal monitor 270 is a display device that is able to display a first through image TH1 corresponding to first image data or a second through image TH2 corresponding to second image data produced by the CCD image sensors 150 (see FIGS. 6 to 9), or first image data and second image data read from the memory card 240, in either 2D or 3D display. Also, the liquid crystal monitor 270 is able to display various kinds of setting information for the digital camera 1. For example, the liquid crystal monitor 270 can display the EV value, the F value, the shutter speed, the ISO sensitivity, or the like, which are imaging conditions during imaging. A “through image” here is moving pictures that appears on the liquid crystal monitor 270 by the successive display of images. This through image is used by the user to decide on the composition of the subject, and the through image itself is usually not stored in the memory card 240.

In the case of 2D display, the liquid crystal monitor 270 pertaining to this embodiment displays the first through image TH1 and the second through image TH2 side by side on the left and right, but this is not the only option. Just the through image selected by the controller 210 from among the first through image TH1 and the second through image TH2 may be displayed, or the first through image TH1 and the second through image TH2 may be displayed one above the other. Or, the first through image TH1 and the second through image TH2 may be displayed alternately from line to line. In the case of 3D display, the first through image TH1 and the second through image TH2 may be displayed in frame sequence on the liquid crystal monitor 270, or the first through image TH1 and the second through image TH2 may be displayed as overlays.

The mode setting switch 290 is used to switch between 2D imaging mode when capturing 2D images with the digital camera 1, 3D imaging mode when capturing 3D images with the digital camera 1, and reproduction mode when reproducing captured images. In 2D imaging mode, the first through image TH1 and the second through image TH2 with different field angles can be captured at the same time. More specifically, in 2D imaging mode, still picture capture of the second through image TH2 during the moving pictures capture of the first through image TH1, and simultaneous still picture capture of the first through image TH1 and the second through image TH2 can both be performed. In 3D imaging mode, the first through image TH1 and the second through image TH2 can be simultaneously captured either as moving pictures or still pictures. With the digital camera 1, the proper imaging parameters for a given mode are set every time the user switches between 2D imaging mode and 3D imaging mode. In the following description, the 2D imaging mode and 3D imaging mode will in some cases be collectively referred to as “imaging mode.”

### 1-2. Controller Configuration

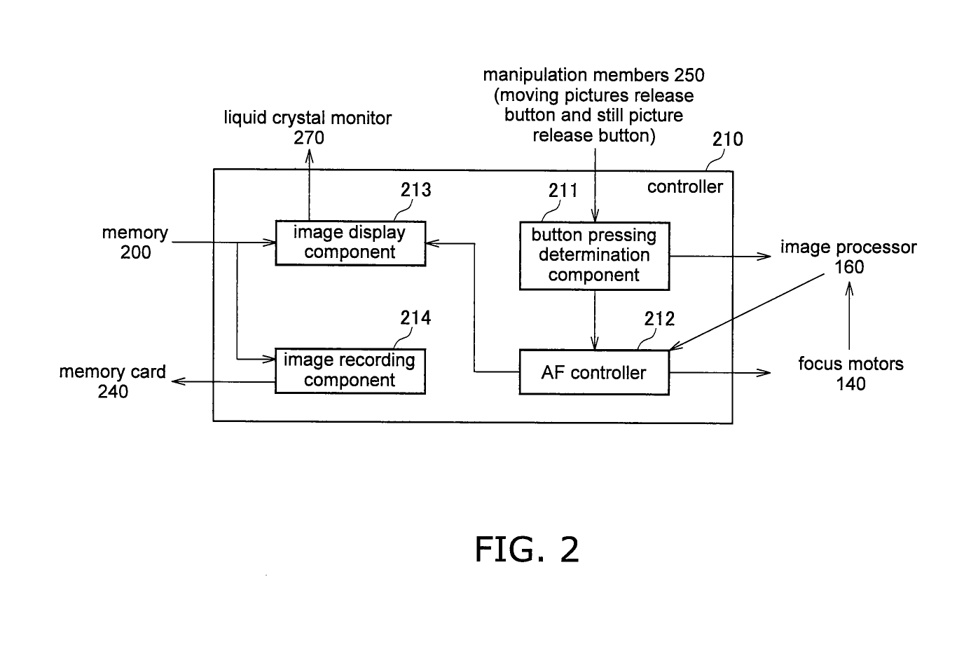

FIG. 2 is a block diagram of the electrical configuration of a controller. The controller 210 is constituted by a button pressing determination component 211, an AF controller 212, an image display component 213, and an image recording component 214.

The button pressing determination component 211 determines whether or not any of the various buttons, which the manipulation members 250 comprise, have been pressed; and sends the determined result to the image processor 160. The image processor 160 executes compression processing or the like on the first image data and second image data according to the notification from the button pressing determination component 211.

Also, the button pressing determination component 211 determines whether or not the moving pictures release button has been pressed to capture a moving picture. If the button pressing determination component 211 determines that the button has been pressed to capture a moving picture, it notifies the AF controller 212.

Also, the button pressing determination component 211 determines whether or not the still picture release button has been pressed half-way down while the moving pictures release button is being pressed to capture a moving picture. In other words, it determines whether or not a command for AF control of the still picture has been received during moving pictures capture. If the button pressing determination component 211 determines that a command for AF control of the still picture has been received during moving pictures capture, it notifies the AF controller 212 to this effect.

Also, the button pressing determination component 211 determines whether or not the still picture release button has been pressed half-way down while the moving pictures release button is not being pressed to capture a moving picture, that is, whether or not a command for AF control of the still picture has been received when moving pictures capture is not in progress. If the button pressing determination component 211 determines that a command for AF control of the still picture has been received when moving pictures capture is not in progress, it notifies the AF controller 212 to this effect.

If a notification is received from the button pressing determination component 211 to the effect that a command for moving pictures capture has been received, the AF controller 212 the focus motor 140(a) is controlled so that the focus is continuously adjusted for the subject image formed by the CCD image sensor 150(a). In this case, the AF controller 212 notifies the image display component 213 that AF control of the CCD image sensor 150(a) is continuing.

Also, if a notification is received from the button pressing determination component 211 to the effect that a command for AF control of a still picture has been received during moving pictures capture, the AF controller 212 continues adjusting the focus of the CCD image sensor 150(a), while the focus motor 140(b) is control so as to adjust the focus of the subject image formed by the CCD image sensor 150(b). In this case, the AF controller 212 notifies the image display component 213 that AF control of the CCD image sensor 150(a) is continuing and that AF control of the CCD image sensor 150(b) has ended.

Also, if a notification is received from the button pressing determination component 211 to the effect that a command for AF control of a still picture has been received when moving pictures capture is not in progress, the AF controller 212 simultaneously executes the focal adjustment of the CCD image sensor 150(a) with the focus motor 140(a) and the focal adjustment of the CCD image sensor 150(b) with the focus motor 140(b). In this case, the AF controller 212 notifies the image display component 213 that AF control of the CCD image sensor 150(a) and the CCD image sensor 150(b) has ended.

The AF controller 212 executes AF control according to a known procedure, described below. First, the AF controller 212 changes the position of the focus lenses 113 by controlling the focus motors 140, after which it acquires an image processing result for contrast AF with the image processor 160. The AF controller 212 repeatedly controls the focus motors 140 until the proper image processing result is obtained, that is, until the AF control ends.

When the mode setting switch 290 is used to switch to 2D imaging mode, the image display component 213 successively sends to the liquid crystal monitor 270 the first image data and second image data outputted from the memory 200, and as a result the first through image TH1 and the second through image TH2 are displayed side by side on the liquid crystal monitor 270.

Also, if a notification is received from the AF controller 212 to the effect that AF control of the CCD image sensor 150(a) is continuing, the image display component 213 displays moving pictures mark 100(a) on the liquid crystal monitor 270 (see FIG. 7). The moving pictures mark 100(a) shows that moving pictures corresponding to the first through image TH1 is being captured, and that AF control of the CCD image sensor 150(a) is continuing.

Also, if a notification is received from the AF controller 212 to the effect that AF control of the CCD image sensor 150(a) is continuing, and that AF control of the CCD image sensor 150(b) has ended, the image display component 213 displays the moving pictures mark 100(a) and a still picture mark 100(b) on the liquid crystal monitor 270 (see FIG. 8). The still picture mark 100(b) shows that a still picture corresponding to the second through image TH2 has been captured, and that AF control of the CCD image sensor 150(b) has ended.

Also, if a notification is received from the AF controller 212 to the effect that AF control of the CCD image sensor 150(a) and the CCD image sensor 150(b) has ended, the image display component 213 displays the still picture mark 100(b) and a still picture mark 100(c) on the liquid crystal monitor 270 (see FIG. 9). The still picture mark 100(c) shows that a still picture corresponding to the first through image TH1 has been captured, and that AF control of the CCD image sensor 150(a) has ended.

As will be discussed below, the image display component 213 displays the moving pictures mark 100(a) or the still picture mark 100(c) superposed over the first through image TH1, and displays the still picture mark 100(b) superposed over the second through image TH2.

The image recording component 214 reads the image data in the memory 200, and records moving pictures corresponding to the first image data or a still picture corresponding to the second image data to the memory card 240.

### 1-3. Image Data Capture Operation

The operation of capturing image data with the digital camera 1 will now be described.

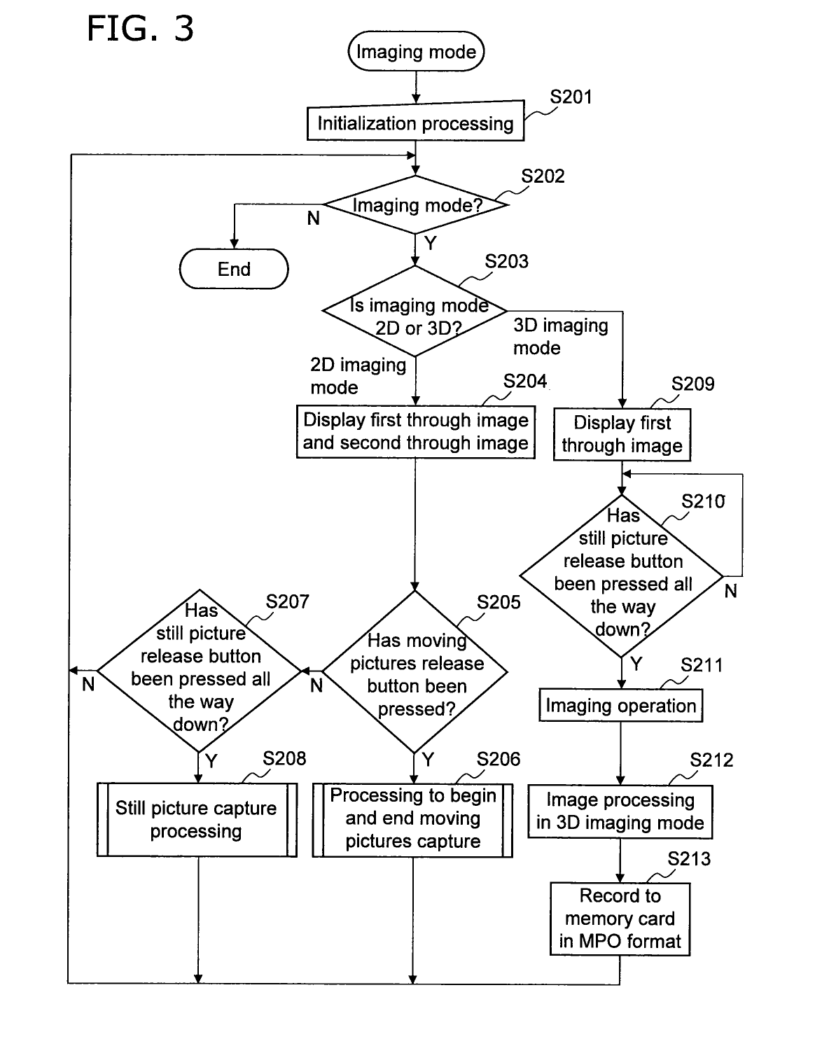

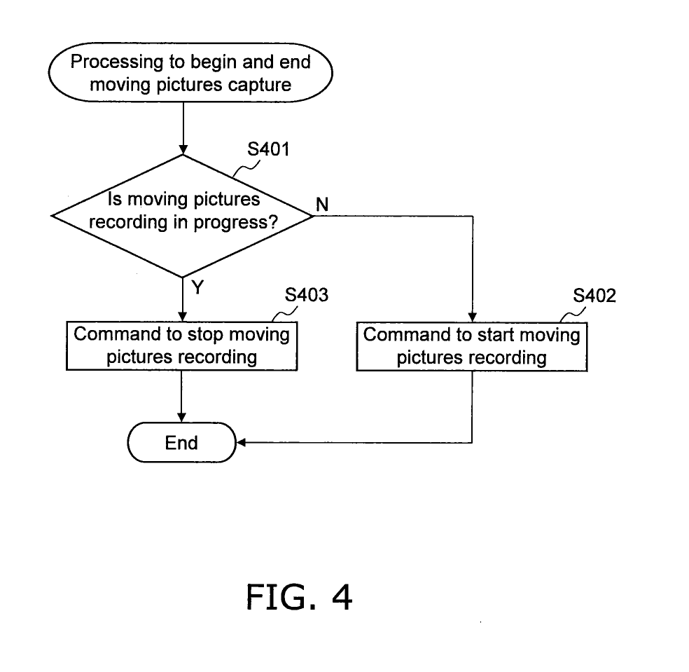

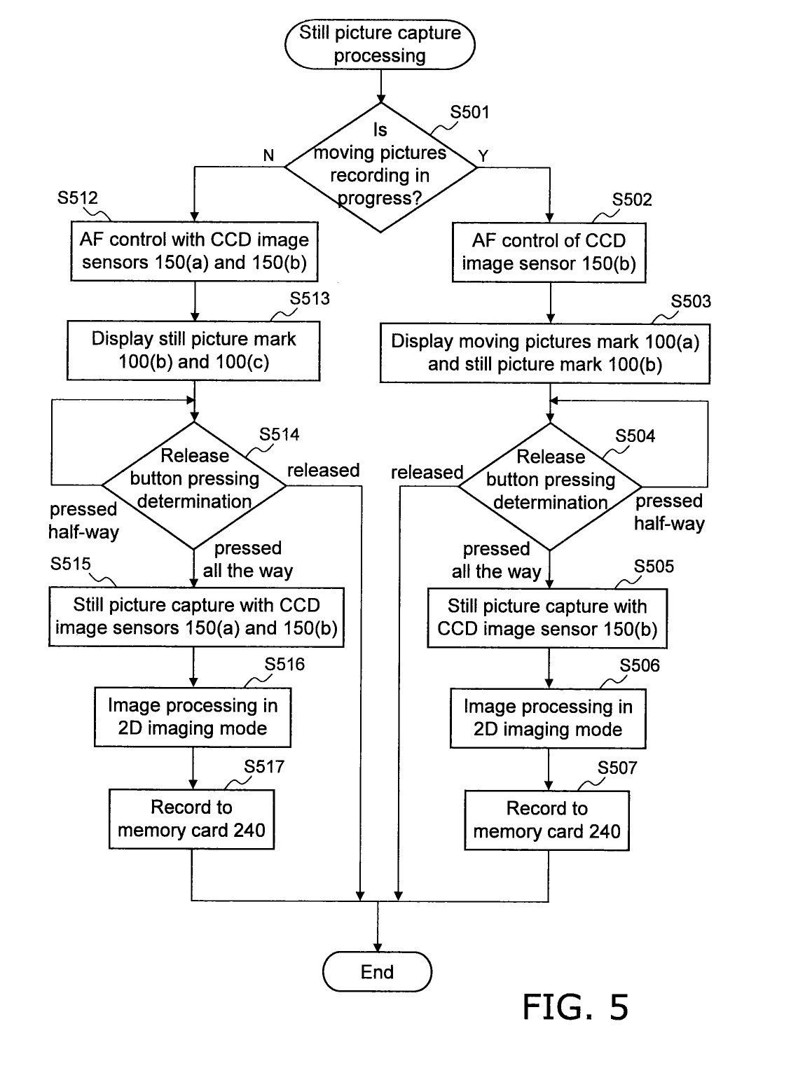

FIG. 3 is a flowchart illustrating the simplified imaging operation of the digital camera 1. FIG. 4 is a flowchart illustrating the moving pictures capture operation of the digital camera 1. FIG. 5 is a flowchart illustrating the still picture capture operation of the digital camera 1. And FIGS. 6 to 9 are simplified diagrams of examples of display on the liquid crystal monitor liquid crystal monitor 270 in 2D imaging mode.

When an imaging mode has been selected, the controller 210 first executes initialization processing for that imaging mode (S201).

The controller 210 determines whether or not the mode setting switch 290 indicates an imaging mode (S202). If the mode setting switch 290 does indicate an imaging mode, the flow proceeds to step S203. If the mode setting switch 290 does not indicate an imaging mode, the imaging mode is ended.

The controller 210 determines whether the imaging mode is 2D imaging mode or 3D imaging mode (S203). If it is 2D imaging mode, the flow proceeds to step S204. On the other hand, if it is 3D imaging mode, the flow proceeds to step S209.

In 2D imaging mode, the controller 210 displays the first through image TH1 corresponding to the first image data and the second through image TH2 corresponding to the second image data (S204). FIG. 6 shows a display example of the first through image TH1 and second through image TH2 at the point when the system switches to 2D imaging mode. The field angles of the first through image TH1 and the second through image TH2 are different from one another.

The controller 210 determines whether or not it has been detected that the moving pictures release button (part of the manipulation members 250) has been pressed (S205). If it is detected that the moving pictures release button has been pressed, the processing returns to step S202 after processing to begin or end moving pictures imaging (S206). The processing to begin or end moving pictures imaging will be described in detail through reference to the flowchart in FIG. 4. If it is not detected that the moving pictures release button has been pressed, the flow proceeds to step S207.

The controller 210 determines whether or not the still picture release button (part of the manipulation members 250) has been pressed half-way down (S207). If the controller 210 detects that the still picture release button has been pressed half-way down, the processing returns to step S202 after still picture capture processing (S208) has been performed. This still picture capture processing will be described in detail with reference to the flowchart in FIG. 5. If it is not detected that the still picture release button has been pressed half-way down, the flow returns to step S202.

If the controller 210 determines in step S203 that the system is in 3D imaging mode, the first through image TH1 is displayed (S209).

The controller 210 determines whether or not the still picture release button (part of the manipulation members 250) has been pressed all the way down (S210). If the still picture release button has been pressed all the way down, the processing proceeds to step S211. If the still picture release button has not been pressed all the way down, the processing repeats step S210. When the still picture release button is pressed all the way down, the CCD image sensors 150(a) and 150(b) perform an imaging operation on the basis of the imaging conditions set in 3D imaging mode, and produce a pair of first image data and second image data (S211).

When this pair of image data is produced, the image processor 160 performs image processing according to the 3D imaging mode on the pair of image data (S212). Also, the image processor 160 produces a pair of compressed image data on the basis of the pair of image data, and temporarily stores these in the memory 200.

When the pair of compressed image data is stored in the memory 200, the controller 210 records the pair of compressed image data in the memory card 240 (S213). In recording the pair of compressed image data to the memory card 240, the controller 210 using an MPO file format, for example, so that the two sets of compressed image data are associated with one another.

FIG. 4 is a flowchart showing details of the processing to begin or end moving pictures imaging (S206).

When it is detected that the user has pressed the moving pictures release button of the manipulation members 250, the controller 210 determines whether or not the digital camera 1 is in the midst of recording moving pictures (S401).

If it is determined that the digital camera 1 is not in the midst of recording a moving picture, the controller 210 sends a command to the image processor 160 to begin moving pictures recording (S402). In this embodiment, moving pictures recording is performed on the basis of the first image data. In such case, as shown in FIG. 7, the controller 210 displays the moving pictures mark 100(a) superposed over the upper-left portion of the first through image TH1, which shows the captured moving picture. The moving pictures mark 100(a) is a signal indicating that moving pictures corresponding to the first through image TH1 is being captured, and that AF control of the CCD image sensor 150(a) is continuing. A “red circle” or the like can be used, for example. The controller 210 successively records to the memory card 240 the moving pictures image data produced by the image processor 160 on the basis of the first image data, according to the display of the moving pictures mark 100(a).

If it is determined in step S401 that the digital camera 1 is in the midst of recording a moving picture, the controller 210 sends a command to the image processor 160 to stop recording the moving pictures (S403). The image processor 160 therefore stops the production of moving pictures image data based on the first image data.

FIG. 5 is a flowchart showing the details of still picture capture processing (S208).

When it is detected that the user has pressed the still picture release button of the manipulation members 250 half-way down, the controller 210 determines whether or not the recording state of the digital camera 1 is in the midst of recording moving pictures (S501).

If it is determined that the digital camera 1 is in the midst of recording a moving picture, the controller 210 performs AF control of the CCD image sensor 150(b) (S502).

The controller 210 displays the still picture mark 100(b) on the liquid crystal monitor 270 in response to the end of AF control in step S502 (S503). More specifically, as shown in FIG. 8, during still picture capture in the midst of moving pictures capture, the controller 210 displays the moving pictures mark 100(a) in the upper-left portion of the first through image TH1 that shows the moving pictures that is being captured, and also displays the still picture mark 100(b) in the middle portion of the second through image TH2 that shows the still picture that is captured. The still picture mark 100(b) is a signal indicating that a still picture corresponding to the second through image TH2 is captured, and that AF control of the CCD image sensor 150(b) has ended. A “green circle” or the like can be used, for example.

The controller 210 determines the pressed state of the still picture release button of the manipulation members 250 (S504). If the half-way pressing of the still picture release button has been released, the controller 210 clears the display of the still picture mark 100(b) on the second through image TH2, and returns to the state in FIG. 7. If the half-way pressing of the still picture release button continues, the state in FIG. 8 is maintained. If the still picture release button has been pressed all the way down, the processing proceeds to step S505.

If the still picture release button has been pressed all the way down, the controller 210 performs still picture capture with the CCD image sensor 150(b), and produces second image data (S505).

When the second image data is produced, the image processor 160 performs various image processing according to 2D imaging mode on the second image data thus produced (S506). Also, the image processor 160 produces compressed image data on the basis of the second image data, and temporarily stores it in the memory 200.

When the compressed image data is stored in the memory 200, the controller 210 uses a JPEG file format to record the compressed image data to the memory card 240 (S507).

If it is determined in step S501 that the digital camera 1 is not recording a moving picture, the controller 210 performs AF control of the CCD image sensors 150(a) and 150(b) (S512).

The controller 210 displays the still picture marks 100(b) and 100(c) on the liquid crystal monitor 270 in response to the ending of AF control in step S512. More specifically, as shown in FIG. 9, during still picture capture by the CCD image sensors 150(a) and 150(b), the controller 210 displays the still picture mark 100(c) in the middle portion of the first through image TH1 that shows the still picture being captured, and displays the still picture mark 100(b) in the middle portion of the second through image TH2 that shows the still picture being captured. The still picture mark 100(c) is a signal showing that a still picture corresponding to the first through image TH1 has been captured, and that AF control of the CCD image sensor 150(a) has ended, and can be a “green circle” or the like, for example.

The controller 210 determines the pressed state of the still picture release button of the manipulation members 250 (S514). If the half-way-down pressing of the still picture release button has been released, the controller 210 clears the display of the still picture mark 100(c) on the first through image TH1 and the display of the still picture mark 100(b) on the second through image TH2, and returns to the state in FIG. 6. If the half-way-pressed state of the still picture release button is being maintained, the state in FIG. 9 is maintained. If the still picture release button has been pressed all the way down, the processing proceeds to step S515.

If the still picture release button has been pressed all the way down, the controller 210 performs still picture capture with the CCD image sensors 150(a) and 150(b), and produces first image data and second image data (S515).

When the first and second image data are produced, the image processor 160 subjects the first and second image data thus produced to various kinds of image processing according to 2D imaging mode (S516). Also, the image processor 160 produces compressed image data on the basis of the first and second image data, and temporarily stores these in the memory 200.

When the compressed image data is stored in the memory 200, the controller 210 uses a JPEG file format to record the compressed image data to the memory card 240 (S517).

### 1-4. Conclusion

The digital camera 1 pertaining to this embodiment comprises the CCD image sensor 150(a) that captures an image of a subject and outputs first image data, the CCD image sensor 150(b) that captures an image of the subject from a different viewpoint from that of the CCD image sensor 150(a) and outputs second image data, and the controller 210 that displays the still picture mark 100(b) showing that a still picture corresponding to the second through image TH2 has been captured and that AF control of the CCD image sensor 150(b) has ended, when the still picture release button has been pressed while first image data is being recorded as a moving picture.

This configuration allows two 2D images to be captured for a given subject in a single operation. Also, since the still picture mark 100(b) is displayed, which tells the user than second image data is being recorded as a still picture when the still picture release button is pressed while first image data is being recorded as a moving picture, the user can ascertain whether the still picture being captured corresponds to a through image of the first through image TH1 or the second through image TH2.

Also, the digital camera 1 in this embodiment comprises the CCD image sensor 150(a) that captures an image of a subject and outputs first image data, the CCD image sensor 150(b) that captures an image of the subject from a different viewpoint from that of the CCD image sensor 150(a) and outputs second image data, the image processor 160 that outputs the first image data and second image data, and the controller 210 that controls the image processor 160 so that the first image data and the second image data are outputted.

With this configuration, a 3D image that looks three-dimensional can be obtained for a given subject.

### 2. Other Embodiments

In the above embodiment, the first image data was recorded as moving pictures in 2D imaging mode, but the second image data may be recorded as moving pictures instead. In this case, when the still picture release button is pressed half-way down during the moving pictures recording of the second image data, the still picture mark 100(c) may be displayed after the first image data is subjected to AF control.

Also, the still picture marks 100(b) and 100(c) showed that AF control had ended, but the still picture marks 100(b) and 100(c) may instead show whether the first through image TH1 or the second through image TH2 is being captured as the still picture.

Also, if we let the focus setting for the first image data be manual focus (MF), and the focus setting for the second image data be auto focus (AF), the still picture mark 100(b) may be displayed after the second image data is subjected to AF control according to the half-pressing of the still picture release button. Also, the focus setting for the first image data may be auto focus (AF), and the focus setting for the second image data may be manual focus (MF).

Also, in the above embodiment, the second image data was subjected to AF control when the still picture release button was pressed half-way down while the first image data was being recorded as a moving picture, but the AF result may be displayed when AF control is performed on the first image data during moving pictures recording.

Also, the first image data and second image data may both be recorded as moving pictures, or AF control may be performed on both sets of image data during moving pictures recording, and an AF result displayed for the first through image TH1 and for the second through image TH2.

Also, with the digital camera 1 described in the above embodiment, the various blocks may be individually made into chips by using an integrated circuit or other such semiconductor device, or chips may be made that include all or some of these blocks.

Also, the various processing in the above-mentioned embodiment may be accomplished by hardware or by software. Furthermore, the processing may consist of a mixture of hardware and software. If the digital camera pertaining to the above embodiment is realized by hardware, it should go without saying that the timing will need to be adjusted to perform the various processing. In the above embodiment, details about timing adjustment of the various signals produced in an actual hardware design are omitted for the sake of simplifying the description.

The order in which the processing method is executed in the above embodiment is not limited to what was given in the above embodiment, and the execution order can be varied without departing from the gist of the invention.

The specific constitution of the present invention is not limited to or by the above embodiment, and various changes and modifications are possible without departing from the gist of the invention.

What is claimed is:

1. A multi-eye imaging device, comprising:
a first imaging element configured to capture a subject image and output first image data;
a second imaging element configured to capture a second subject image and output second image data;
a moving pictures release button configured to receive an instruction to capture a moving picture corresponding to the first image data;
a still picture release button configured to receive an instruction to capture a still picture corresponding to the second image data and an autofocus (AF) controlling instruction of a subject on the second imaging element;
an image processor configured to begin to capture the moving picture based on the first image data when the moving pictures release button has received the instruction to capture the moving pictures;
a monitor configured to display a first through image corresponding to the first image data and a second through image corresponding to the second image data, the first through image displayed side by side with the second through image; and
an image display component configured to display, the first through image, the second through image, and a still picture mark on the monitor when the still picture release button has received the AF controlling instruction while the image processor is capturing the moving picture, the still picture mark indicating that a still picture corresponding to the second through image will be captured.

2. The multi-eye imaging device according to claim 1, further comprising:
an AF controller configured to execute AF control of a subject on the second imaging element when the still picture release button has been pressed half-way down, wherein
the still picture mark is superimposed on the second through image, the still picture mark showing that AF control by the AF controller has ended.

3. The multi-eye imaging device according to claim 1, further comprising:
a memory component configured to store the moving pictures corresponding to the first image data and the still picture corresponding to the second image data.

4. The multi-eye imaging device according to claim 1, wherein:
the image display component displays a moving pictures mark superimposed on the first through image while the image processor is capturing the moving pictures, the moving pictures mark showing that the moving picture corresponding to the first through image is being captured.

5. The multi-eye imaging device according to claim 1, wherein:
the first imaging element and the second imaging element are separated from each other in a horizontal direction.

6. A multi-eye imaging device, comprising:
a first imaging element configured to capture a subject image and output first image data;
a second imaging element configured to capture a subject image and output second image data;
a moving pictures release button configured to receive an instruction to capture a moving picture corresponding to the first image data;
an image processor configured to begin to capture the moving picture based on the first image data when the moving pictures release button has received the instruction to capture the moving picture;
a monitor configured to display a first through image corresponding to the first image data and a second through image corresponding to the second image data, the first through image displayed side by side with the second through image; and
an image display component configured to display the first through image, the second through image, and a moving pictures mark with on the monitor when the image processor has begun to capture the moving picture, the moving pictures mark showing that a moving picture corresponding to the first through image is being captured.
